(19) United States
(12) Patent Application Publication
(10) Pub. No.: US 2019/0206172 A1
(43) Pub. Date: Jul. 4, 2019

(54) SHEET IDENTIFICATION DEVICE AND SHEET IDENTIFICATION METHOD

(71) Applicant: GLORY LTD., Himeji-shi, Hyogo (JP)

(72) Inventors: Hiroki OJI, Hyogo (JP); Akira NAKASHIMA, Hyogo (JP); Tomohiko KASUYA, Hyogo (JP); Kazuhiro OHMATSU, Hyogo (JP); Satoshi YOSHIDA, Hyogo (JP)

(21) Appl. No.: 16/311,885

(22) PCT Filed: Jun. 29, 2017
(86) PCT No.: PCT/JP2017/023917

§ 371 Date: Dec. 20, 2018

(30) Foreign Application Priority Data
Jun. 30, 2016 (JP) 2016-130727

(51) Int. Cl. G07D 7/12; G07D 7/04; G07D 7/08

(52) U.S. Cl. CPC G07D 7/12; G07D 7/08; G07D 7/04

(57) ABSTRACT

The present invention provides a sheet identification device and a sheet identification method capable of meeting a wider variety of requests. The sheet identification device of the present invention is configured to identify a sheet under transportation. The device includes a standard identifier and an option attachment member to which an optional identifier is attachable. The standard identifier includes a standard sensor unit including an optical line sensor and a standard controller configured to control the standard sensor unit and identify a type of the sheet based on an output from the standard sensor unit. The optional identifier includes an optional sensor unit configured to execute a different sensing operation from a sensing operation executed by the standard sensor unit and an optional controller configured to control the optional sensor unit.

### TECHNICAL FIELD

The present invention relates to sheet identification devices and sheet identification methods. The present invention specifically relates to a sheet identification device and a sheet identification method suitable for identification of a variety of banknotes.

### BACKGROUND ART

Current sheet identification devices include a plurality of sensors in order to meet requests of each country where the devices are used, and such sheet identification devices are used to identify sheets of each country. In the future, some countries may further request detection of security characteristics or damages which are difficult to detect with the sensors mounted on the current devices.

With regard to techniques directed to these requests, Patent Literature 1 discloses a banknote identification device including a body that provides basic performance and a removable part that provides an expansion function needed in accordance with the type of a banknote identification device, wherein the body includes a first sensor configured to execute a first sensing operation on sheets, and the removable part includes a second sensor configured to execute a second sensing operation on the sheets and the removable part is removable from the body.

Patent Literature 2 discloses a banknote identification device that is intended to provide a short transport path that can securely identify and dispense banknotes without passing the banknotes through an identification unit in a dispense operation. This banknote identification device includes an identification data acquisition unit configured to acquire banknote identification data at a position outside the identification unit.

### CITATION LIST

### Patent Literature

Patent Literature 1: JP 2015-82298 A

Patent Literature 2: JP 3622452 B

### SUMMARY OF INVENTION

### Technical Problem

In the banknote identification device of Patent Literature 1, a single controller executes identification of banknotes based on the sensing results from both of the first and second sensing operations. Thus, even if a new removable unit for expansion of an identification capability is prepared so as to meet the requests of each country, the controller that has to control the removable unit may fail to respond to the removable unit and may eventually fail to meet the requests of each country.

The present invention has been made in view of such a current state of the art, and aims to provide a sheet identification device and a sheet identification method capable of meeting a wider variety of requests.

### Solution to Problem

A first aspect of the present invention is a sheet identification device configured to identify a sheet under transportation. The sheet identification device comprises a standard identifier and an option attachment member to which an optional identifier is attachable. The standard identifier comprises a standard sensor unit comprising an optical line sensor and a standard controller configured to control the standard sensor unit and identify a type of the sheet based on an output from the standard sensor unit. The optional identifier comprises an optional sensor unit configured to execute a different sensing operation from a sensing operation executed by the standard sensor unit and an optional controller configured to control the optional sensor unit.

In the first aspect of the present invention, the standard identifier is configured to obtain medium information of the sheet with the standard sensor unit, and the optional controller is configured to control the optional sensor unit based on the medium information obtained by the standard identifier.

In the first aspect of the present invention, the optional identifier is attachable to the option attachment member in such a manner that the optional identifier is apart from the standard identifier.

In the first aspect of the present invention, the optional identifier attachable to the option attachment member in such a manner that the optional identifier is apart from the standard identifier comprises a plurality of optional sensor units, and an optional sensor unit at a most upstream position among the plurality of optional sensor units is configured to detect transport conditions of the sheet.

In the first aspect of the present invention, the optional controller is configured to determine at least one of authenticity and fitness of the sheet based on an output from the optional sensor unit.

In the first aspect of the present invention, the standard controller is configured to determine at least one of authenticity and fitness of the sheet based on the output from the standard sensor unit.

In the first aspect of the present invention, the optional sensor unit comprises at least one sensor selected from the group consisting of an ultrasonic sensor, an optical sensor, a magnetic sensor, a displacement sensor, and a capacitive sensor.

In the first aspect of the present invention, the sheet identification device further comprises the optional identifier attached to the option attachment member.

In the first aspect of the present invention, the sheet identification device further comprises a transporting unit attached to the option attachment member, but does not comprise the optional identifier.

In the first aspect of the present invention, the optional identifier comprises a plurality of optional sensor units, and the plurality of optional sensor units is attachable to the option attachment member.

In the first aspect of the present invention, each optional sensor unit of the plurality of optional sensor units is configured to execute a different sensing operation.

In the first aspect of the present invention, each optional sensor unit of the plurality of optional sensor units comprises a different sensor.

In the first aspect of the present invention, each optional sensor unit of the plurality of optional sensor units has the same dimension in a transport direction of the sheet.

In the first aspect of the present invention, each optional sensor unit of the plurality of optional sensor units is attachable to the same site of the option attachment member.

In the first aspect of the present invention, each optional sensor unit of the plurality of optional sensor units is attachable inline to the option attachment member.

Each optional sensor unit of the plurality of optional sensor units is arrangeable in any order in a transport direction of the sheet.

An optional sensor unit that causes a longer period of identification with the optional controller among the plurality of optional sensor units is placed at a more upstream position.

A second aspect of the present invention is a sheet identification method for identifying a sheet under transportation. The method comprises controlling a standard sensor unit comprising an optical line sensor by a standard controller; identifying a type of the sheet by the standard controller based on an output from the standard sensor unit; and controlling, by an optional controller, at least one optional sensor unit selected from a plurality of optional sensor units, the plurality of optional sensor units each being configured to execute a different sensing operation from a sensing operation executed by the standard sensor unit.

### Advantageous Effects of Invention

The sheet identification device and the sheet identification method of the present invention can meet a wider variety of requests.

### BRIEF DESCRIPTION OF DRAWINGS

FIG. 1 is a schematic perspective view of a sheet handling device according to Embodiment 1 of the present invention.

FIG. 2 is a schematic view of an internal structure of the sheet handling device according to Embodiment 1 of the present invention.

FIG. 3 is a schematic perspective view of a sheet identification device according to Embodiment 1 of the present invention.

FIG. 4 is a schematic cross-sectional view of the sheet identification device according to Embodiment 1 of the present invention.

FIG. 5 is a functional block diagram of the sheet identification device according to Embodiment 1 of the present invention.

FIG. 6 is a schematic view for describing a method of collecting image data with an optical line sensor for optical variable ink detection by an optional controller in the sheet identification device according to Embodiment 1 of the present invention, showing collected image data of the entire surface detected by the optical line sensor for optical variable ink detection.

FIG. 7 is another schematic view for describing a method of collecting image data with an optical line sensor for optical variable ink detection by an optional controller in the sheet identification device according to Embodiment 1 of the present invention, showing collected image data of only a region where an optical variable ink is imaged by the optical line sensor for optical variable ink detection.

FIG. 8 is a schematic plan view of the relationship between the width of a transport path and the scanning widths of sensors in the sheet identification device according to Embodiment 1 of the present invention.

FIG. 9 is another schematic plan view of another relationship between the width of a transport path and the scanning widths of sensors in the sheet identification device according to Embodiment 1 of the present invention.

FIG. 10 is a schematic perspective view of a sheet identification device according to Embodiment 2 of the present invention.

FIG. 11 is a functional block diagram of the sheet identification device according to Embodiment 2 of the present invention.

FIG. 12 is a schematic cross-sectional view of a sheet identification device according to Embodiment 3 of the present invention.

### DESCRIPTION OF EMBODIMENTS

### Embodiment 1

Hereinafter, a preferred embodiment of the sheet identification device and the sheet identification method of the present invention is described in detail with reference to the drawings. A sheet identification device and a sheet identification method of the present embodiment are used for identification of a type or authenticity of sheets under transportation in a sheet handling device.

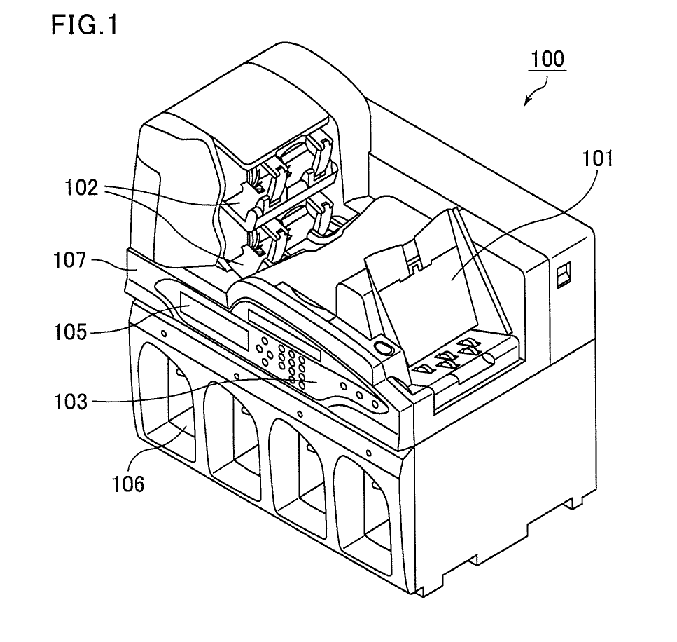

First, the overall structure of the sheet handling device according to the present embodiment is described. As shown in FIG. 1, a sheet handling device 100 of the present embodiment is a small banknote handling device used on a table. The sheet handling device 100 comprises: the sheet identification device (not illustrated in FIG. 1) configured to identify the sheets; a hopper 101 configured to receive a stack of the sheets to be handled; two rejectors 102 configured to discharge a sheet fed from the hopper 101 into a housing 107 if the sheet is, for example, a banknote to be rejected such as a counterfeit note; a control panel 103 configured to receive an instruction input by an operator; four stackers 106 configured to sort and stack fit sheets whose type (e.g., denomination for banknotes) and authenticity have been identified in the housing 107; and a display 105 configured to display information such as the results of identifying and counting the sheets and the stacking states of the stackers 106. The sheets fed from the hopper 101 into the housing 107 one by one are transported along a transport path and identified by the sheet identification device. A sheet identified as a counterfeit note or a suspect note may be discharged by either of the rejectors 102, or may be stored in any of the stackers 106.

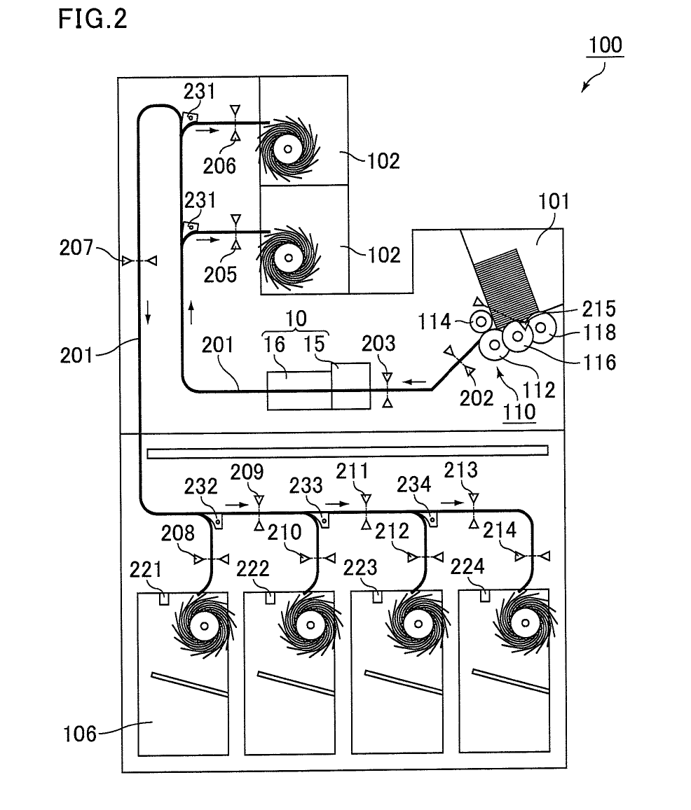

FIG. 2 mainly shows a transport system and a sensor system of the sheet handling device 100. As shown in FIG. 2, the sheet handling device 100 is provided inside with a transport path 201 configured to transport the sheets from the hopper 101 to corresponding stackers 106. This transport path 201 is usually constituted by a combination of belt transport mechanisms. Various sensors 202, 203, and 205 to 215 are placed along the transport path 201. The sensor 202, which is a sheet feed detection sensor, placed on the outlet of the hopper 101 and the sensor 203 placed on the inlet of the sheet identification device 10 are configured to detect secure feeding of the sheets. The sheet identification device 10 placed in the transport path 201 is constituted by a variety of detectors and comprises a standard identifier 15 and an optional identifier 16.

Two diverters 231 are disposed in series downstream of the sheet identification device 10 in the transport path 201. Each diverter 231 is configured to deliver, to the corresponding rejector 102, a sheet such as a sheet which fails to be identified by the sheet identification device 10 or a sheet which is identified but fails to be classified. The sensors 205 and 206 are each configured to detect delivery of a sheet from the corresponding diverter 231 to the corresponding rejector 102. The transport conditions of a sheet to be classified are detected by the sensor 207, and this sheet is further transported in the transport path 201. Three diverters 232 to 234 are disposed in series downstream of the diverters 231 in the transport path 201. The diverters 232 to 234 are each configured to deliver, for example, the sheets transported from the diverters 231 to the corresponding stackers 106 among the four stackers 106 in accordance with characteristics of the sheets such as the denomination. Thereby, a sheet whose characteristic such as the denomination is identified by the sheet identification device 10 is stored in the corresponding stacker 106 among the four stackers 106. The sensors 208 to 214 are configured to detect whether or not the sheets are correctly classified into the corresponding stackers 106 from the transport path 201. Further, as shown in FIG. 2, the hopper 101 is provided with the sensor 215. This sensor 215 is configured to detect storage of a sheet in the hopper 101. The storage conditions of sheets in the stackers 106 are to be detected by residual sheet detection sensors 221 to 224.

The sheet feeding mechanism 110 is configured to deliver sheets stored in the hopper 101 one by one to the transport path 201 in the sheet handling device 100.

The hopper 101 is configured to store sheets such that the sheets are stacked on the bottom of the hopper. As shown in FIGS. 1 and 2, the hopper 101 is opened at the top and the front (the right side in FIG. 2). Further, as mentioned above, the hopper 101 is provided with the sensor 215 configured to detect storage of even only a single sheet in the hopper 101.

The sheet feeding mechanism 110 comprises a first kicker roller 116 that is to be in contact with a face of a sheet at the bottom among a plurality of sheets stacked in the hopper 101, a second kicker roller 118 that is upstream of the first kicker roller 116 in the direction of feeding the sheets, and a feed roller 112 that is downstream of the first kicker roller 116 in the direction of feeding the sheets and is configured to feed the sheets discharged by the first kicker roller 116. A gate roller (reverse roller) 114 is also disposed opposite to the feed roller 112, and the feed roller 112 and the gate roller 114 constitute a gate therebetween. The sheets discharged by the first kicker roller 116 are to be fed one by one through the gate into the transport path 201.

As shown in FIG. 2, the sheet feed detection sensor 202 disposed at the outlet of the sheet feeding mechanism 110 is configured to detect a trouble such as a jam in feeding of sheets by the sheet feeding mechanism 110. Specifically, this sheet feed detection sensor 202 is configured to detect occurrence of a trouble such as a jam in feeding of sheets by the sheet feeding mechanism 110 when the sheet feed detection sensor 202 fails to detect feeding of a sheet even after a predetermined feeding error detection period has passed from when it detected feeding of the previous sheet during feeding of sheets by the sheet feeding mechanism 110.

The sensors 202, 203, 205 to 215, and 221 to 224 used are each usually a light-reflective or light-transmissive photo-sensor. Alternatively, these sensors each may be a sensor configured to mechanically detect passage of a sheet 1 or a sensor utilizing ultrasonic waves.

Examples of the sheet include, but are not limited to, banknotes, gift vouchers, checks, documents of value, and card-like media. The paper used for banknotes is mainly paper made from vegetable fiber. Still, in order to improve characteristics such as durability, water resistance, and security performance, synthetic paper made from synthetic fiber or a sheet of synthetic resin, i.e., a polymer sheet, may be used. Banknotes made from a polymer sheet are called polymer banknotes.

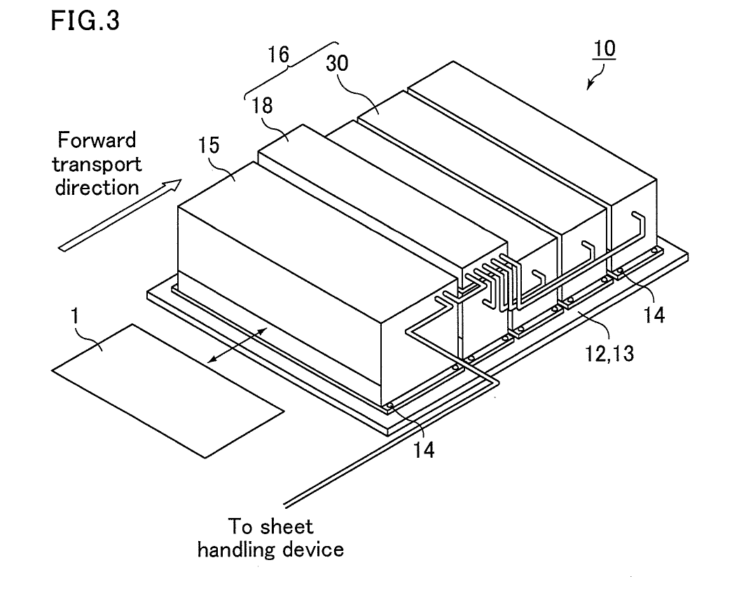

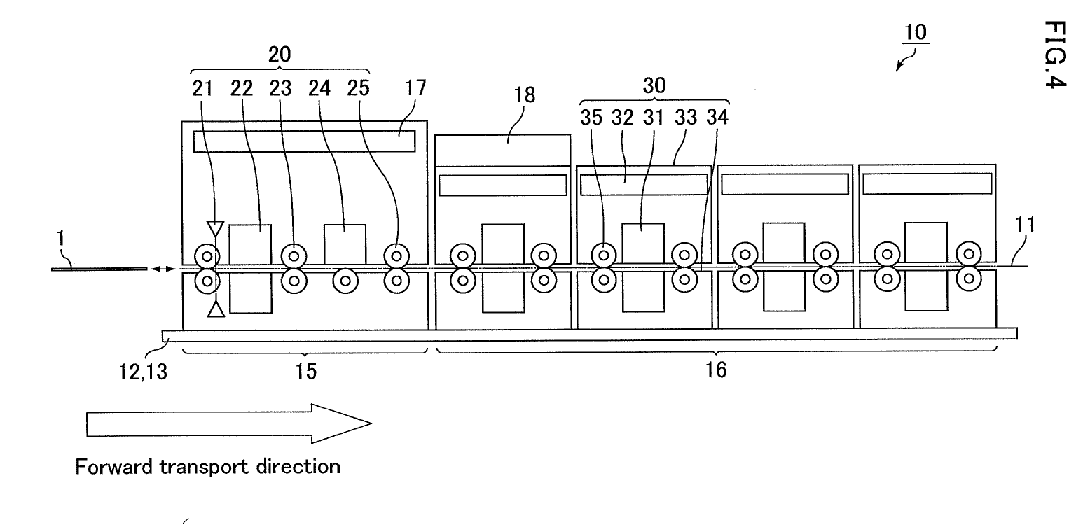

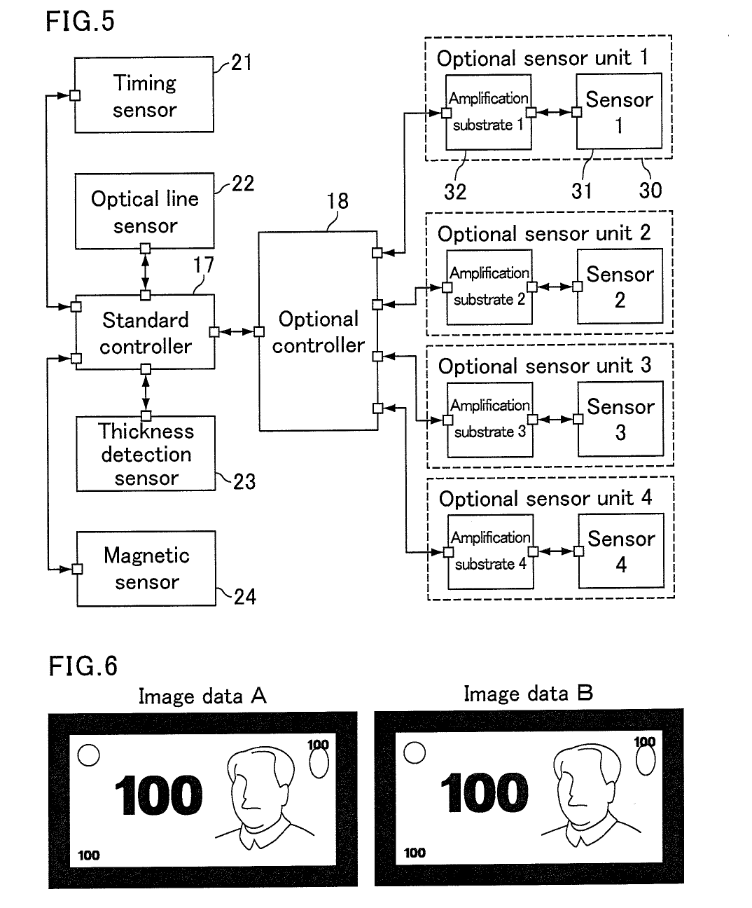

Next, the sheet identification device 10 of the present embodiment is described in detail. As shown in FIGS. 3 to 5, the sheet identification device 10 of the present embodiment comprises a standard identifier 15 and an option attachment member 12 to which an optional identifier 16 is attachable. In the present embodiment, the optional identifier 16 is attached to the option attachment member 12. The sheet 1 is transported such that it passes the standard identifier 15 and then the optional identifier 16 from the previous stage (hopper 101), or such that it passes the optional identifier 16 and then the standard identifier 15 from the post stage. Hereinafter, the transport direction from the previous stage (upstream) to the post stage (downstream) is also referred to as the forward transport direction, while the transport direction from the post stage (downstream) to the previous stage (upstream) is also referred to as the reverse transport direction. The standard identifier 15 is designed to be able to identify the sheet 1 when the sheet 1 is transported in either the forward transport direction or the reverse transport direction, but the optional identifier 16 is designed to be able to identify the sheet 1 only when the sheet 1 is transported in the forward transport direction.

Sensors of the standard identifier 15 and the optional identifier 16 to be mentioned later scan the sheet 1 under transportation in the transport direction to provide the information relating to the sheet 1 obtained from the sensors (hereinafter, also referred to as sheet information). Based on this information, the sheet identification device 10 identifies the sheet 1. Examples of the identification executed by the sheet identification device 10 (the standard identifier 15 and the optional identifier 16) include, but are not limited to, a variety of functions such as identification of the type of the sheet 1 (e.g., the denomination for banknotes), determination of the authenticity or fitness of the sheet 1, determination of the orientation or face/back of the sheet 1, acquisition of the information about the outer shape or passing position of the sheet 1, and reading of symbols such as figures and letters printed on the sheet 1.

The standard identifier 15 comprises a standard sensor unit 20 that comprises a timing sensor 21, an optical line sensor 22 configured to apply a plurality of light rays such as infrared rays and visible rays to determine the optical properties of the sheet 1 and obtain optical image information of the sheet 1, a thickness detection sensor 23 configured to determine the thickness of the sheet 1, and a magnetic sensor 24 configured to determine the magnetic properties of the sheet 1. The sensors 21, 22, 23, and 24 are connected to a standard controller 17, and the standard controller 17 is connected to the sheet handling device 100 which is a device on which the controller is mounted. The standard sensor unit 20 is provided with a plurality of rollers 25 as a transporter so as to move the sheet 1 in the transport path 11. The rollers 25 are driven by a driver such as a motor which is not shown in the figure.

The timing sensor 21 is configured to detect the sheets 1 successively transported into the standard sensor unit 20, and to generate a sheet entry detection signal for deciding the timing of starting determination of each sheet 1 in the standard sensor unit 20 and the optional sensor unit 30. The timing sensor 21 used is usually a light-reflective or light-transmissive photo-sensor. Alternatively, this sensor may be a sensor configured to mechanically detect passage of the sheet 1 or a sensor utilizing ultrasonic waves.

The standard identifier 15 further comprises the standard controller 17 configured to control the sensors 21, 22, 23, and 24 of the standard sensor unit 20. The standard controller 17 may be constituted by components such as software programs for executing a variety of processing operations, a central processing unit (CPU) configured to execute the software programs, a variety of hardware components to be controlled by the CPU, a memory unit constituted by storage devices such as a logical device, e.g., a field programmable gate array (FPGA), a volatile or non-volatile memory, or a hard disk drive, and a substrate with these components mounted thereon. The software programs and data required for working of the components may be stored in the memory unit or a dedicated memory, such as RAM or ROM, or hard disk drive separately prepared. The memory unit is also used to store a variety of templates (e.g., reference image data) and threshold values to be used for identification by the standard controller 17.

The standard controller 17 is configured to execute a step of controlling the standard sensor unit 20 that comprises the sensors 21, 22, 23, and 24. Specifically, the standard controller 17 is configured to control the timing of sensing operations by the sensors 21, 22, 23, and 24 and collect, i.e., read output data (output signals) from the sensors 21, 22, 23, and 24. If necessary, the standard controller 17 may be configured to execute a variety of data processing operations, such as amplification, noise reduction, A/D conversion (digitization), imaging, and image correction, on the collected output data and store the processed data in the memory unit of the standard identifier 15.

The standard controller 17 is further configured to identify the sheet 1 based on the data thus obtained from the sensors 21, 22, 23, and 24. For example, the standard controller 17 executes a step of identifying the type of the sheet 1 based on the output from the standard sensor unit 20. This identification is a common technique in the field of banknote handling machines, and thus the detailed description thereof will not be elaborated upon here.

The optional identifier 16 comprises one or more optional sensor units 30 each of which comprises a sensor 31 and an amplification substrate 32, and an optional controller 18 that is configured to control the sensors 31 of the respective optional sensor units 30 and identify the sheet 1 based on the outputs from the sensors 31 of the respective optional sensor units 30. Each sensor 31 is connected to the corresponding amplification substrate 32. Each amplification substrate 32 is connected to the optional controller 18. The optional controller 18 is connected to the standard controller 17 and/or the sheet handling device 100.

The optional sensor units 30 are each unitized in the same shape, and the optional sensor units 30 are designed such that they have the same dimension in the transport direction of the sheet 1. These optional sensor units 30 are designed such that they are attachable to the same site of the option attachment member 12. Further, these optional sensor units 30 are designed such that they are attachable to the option attachment member 12 in line in the transport direction of the sheet 1. Further, these optional sensor units 30 are designed such that they are arrangeable in any order in the transport direction of the sheet 1. In other words, the order of arranging the optional sensor units 30 in the transport direction of the sheet 1 can be determined as appropriate. An optional sensor unit 30 that causes a longer period of identification with the optional controller 18 among the optional sensor units 30 may be placed at a more upstream position.

Each optional sensor unit 30 has a structure in which two substantially cuboid-like housings 33 and 34 that extend in the direction perpendicular to the transport direction of the sheet 1 face each other across the transport path 11. Each sensor 31 is disposed on at least one of the housings 33 and 34, and the amplification substrate 32 is disposed on the housing 33. Each optional sensor unit 30 is provided with a plurality of rollers 35 as a transporter so as to transport the sheet 1 in the transport path 11. The rollers 35 are driven by a driver such as a motor which is not shown in the figure. The sheet 1 is to be transported between the housings 33 and 34 by the rollers 35.

The one or more optional sensor units 30 are those appropriately selected from the plurality of the optional sensor units 30 and attached to the option attachment member 12. Each optional sensor unit 30 is disposed on the post stage (downstream) and close to the standard identifier 15. In the case of using a plurality of the optional sensor units 30, these optional sensor units 30 are arranged in series following the standard identifier 15. The optional controller 18 is configured to execute a step of controlling at least one optional sensor unit 30 selected from the plurality of the optional sensor units 30.

The option attachment member 12 is constituted by a flat plate 13 such as a metal plate. To this flat plate 13 is attached the housing 34 of each optional sensor unit 30 with a fixing part 14 such as a screw, so that the optional identifier 16 is attached to the option attachment member 12. The standard identifier 15 is also attached to the flat plate 13 with the fixing part 14. The optional controller 18 is attached to any of the optional sensor units 30, preferably the optional sensor unit 30 (the housing 33 thereof) closest to the standard identifier 15.

In order to achieve easy maintenance, an end of each housing 33 in the longitudinal direction is rotatably supported by the counter end of the corresponding housing 34. Thereby, each housing 33 can be open and closed around this end.

The optional sensor units 30 are designed to be able to detect different pieces of the sheet information. The optional sensor units 30 may comprise a plurality of optional sensor units 30 each comprising the same sensor 31, but they preferably comprise different sensors 31. Thereby, the optional sensor units 30 can easily execute different sensing operations, easily detecting various pieces of the sheet information.

The sensors 31 of the optional sensor units 30 may be of any type. Examples of preferred sensors include ultrasonic sensors, optical sensors such as optical line sensors, magnetic sensors, displacement sensors, and capacitive sensors. A magnetic sensor to serve as a sensor 31 is usually designed to be able to detect a different piece of sheet information from that detected by the magnetic sensor 24. An ultrasonic sensor can detect a tear in the sheet 1. An optical sensor enables fluorescence detection, phosphorescence detection, special ink detection, and/or spectrum detection. A magnetic sensor enables collection of data with a different resolution from that of the data collected by the magnetic sensor 24, detection of metallic material, and/or detection of magnetism. A displacement sensor enables detection of sheet thickness, specifically detection of tape and/or detection of transportation of two stacked sheets. A capacitive sensor enables detection of sticking of foreign matter, detection of weakening (limpness), and/or detection of water absorption.

The optional sensor units 30 are configured to execute a different sensing operation from that executed by the standard sensor unit 20. In other words, the sensor 31 of each optional sensor unit 30 is configured to execute a different sensing operation from those executed by the sensors 21, 22, 23, and 24 of the standard sensor unit 20 and to detect a different piece of the sheet information from those detected by the sensors 21, 22, 23, and 24.

Each amplification substrate 32 is provided with a drive circuit configured to generate an input signal (drive signal) of the corresponding sensor 31 and circuits configured to execute a variety of data processing operations, such as amplification, noise reduction, and A/D conversion (digitization), on an output signal of the corresponding sensor 31.

The optional controller 18 is constituted by components such as software programs for executing a variety of processing operations, a CPU configured to execute the software programs, a variety of hardware components to be controlled by the CPU, a memory unit constituted by storage devices such as a logical device, e.g., an FPGA, a volatile or non-volatile memory, or a hard disk drive, and a substrate with these components mounted thereon. The software programs and data required for working of the components may be stored in the memory unit or a dedicated memory, such as RAM or ROM, or hard disk drive separately prepared. The memory unit is also used to store a variety of templates (e.g., reference image data) and threshold values to be used for identification by the optional controller 18.

The optional controller 18 is configured to receive the sheet information from the standard controller 17 and control the optional sensor units 30 based on the information. First, the optional controller 18 receives, from the standard controller 17, medium entry information based on the sheet entry detection signal generated by the timing sensor 21. The optional controller 18 controls the timing of sensing by each sensor 31 based on this medium entry information. The optional controller 18 then collects, i.e., reads the output data (output signals) from the respective sensors 31. It may not be preferred that the optional controller 18 unconditionally collects the information of the entire detection surface from each sensor 31. For example, if an ultrasonic sensor serving as a sensor 31 emits ultrasonic waves to an end of the sheet 1, it may receive an unnecessary noise component and fail to receive desired signal information. Thus, it is not preferred to emit ultrasonic waves to an end of the sheet 1. As described here, the surface to be detected by the sensor 31 of each optional sensor unit 30 may have a site where the sheet 1 is not preferred to be detected. Conversely, there may be a case where only a specific site of the detection surface is desired to be detected.

Thus, in the present embodiment, the optional controller 18 is provided with the medium information by the sensors, such as the optical line sensor 22, of the standard identifier 15 in advance, and each sensor 31 of the optional controller 18 is controlled in a pinpoint manner as appropriate. This enables reduction of unnecessary noise and detection of predominantly desired signal information alone without excessive processing time. The medium information may be any information of the sheet 1, and examples thereof include the type (denomination for banknotes), four orientations, i.e., face up, face down, and two orientations, positions (e.g., position in the transverse direction of the transport path 201), authenticity, shape, thickness, and combination of these pieces of information of the sheet 1. These pieces of the medium information may be sent either collectively or dividedly from the standard controller 17 to the optional controller 18.

The following gives control examples.

(1) The optical line sensor 22 (an example) of the standard identifier 15 obtains medium information.

(2) The medium information obtained is sent in real time together with the corresponding medium ID to the optional controller 18.

(3) Based on the medium information received, the optional controller 18 controls the sensors 31 and collects data from the sensors 31 through the respective amplification substrates 32.

As mentioned above, in the present embodiment, the optional controller 18 can be provided with the medium information in advance before control of the sensors 31 and collection of data from the sensors 31, and thus can detect (scan) any site on the sheet 1 in a pinpoint manner. Further, the optional controller 18 can execute control of not scanning an end of the sheet 1 or of scanning only a specific site on the sheet 1. This can eliminate the influence of noise at the end of the sheet 1 and can shorten the scanning (sampling) time.

Then, the optional controller 18 executes, if necessary, a variety of data processing operations such as imaging and image correction on the collected output data, and stores the processed data in the memory unit of the optional controller 18.

The optional controller 18 further executes identification of the sheet 1, preferably determination of the authenticity and/or fitness of the sheet 1, based on the data (detection results) thus obtained from the sensors 31. Specifically, for example, the optional controller 18 compares the data obtained from an ultrasonic sensor with a threshold value for tear detection stored in the memory unit and checks any tear of the sheet 1. The optional controller 18 also sends the results of the identification based on the data obtained from the sensors 31 to the standard controller 17.

The standard controller 17 then executes final identification, preferably final determination relating to the authenticity and/or the fitness of the sheet 1 based on the identification results of the optional controller 18 and the identification results of itself.

In the present embodiment, the optional sensor units 30 are designed such that they are arrangeable in any order in the transport direction of the sheet 1. This enables expansion of the identification functions of the sheet identification device 10 while satisfying predetermined conditions (limitations).

Specifically, an optional sensor unit 30 that causes a longer period of identification based on the output from the sensor among the optional sensor units 30 may be placed at a more upstream position, in other words, a position closer to the standard identifier 15, so as to reduce the influence of the time-consuming identification on the entire period of identification. The sheet 1 is provided with, as an anti-counterfeit technology, an optical variable device (OVD) that generates optical effects such as color or pattern changes utilizing an optical device such as a diffraction grating, a membrane, or a microlens. An example thereof is an optical variable ink (OVI) which is a type of special ink. Examples of an optional sensor unit 30 that causes a longer period of identification with the optional controller 18 include those comprising such an optical line sensor for optical variable ink detection.

The optical variable ink is an ink that generates optical effects such as color or pattern changes utilizing a membrane. Specifically, as the angle of light incident on the optical variable ink and/or the angle of viewing the optical variable ink are/is changed, the appearance of the optical variable ink, such as the color or pattern, changes. Thus, in the optical line sensor for optical variable ink detection, optical components such as a light source and a photodetector are arranged so as to output at least two image data sets with different directions of light irradiation and/or different directions of receiving light reflected on the optical variable ink. Further, detection of an optical variable ink requires high-resolution image data. This causes identification to take a long time based on the image data obtained from the optical line sensor for optical variable ink detection.

By arranging an optional sensor unit 30 affected by a positional deviation close to the standard identifier 15, it is possible to reduce the influence of the positional deviation on the optional sensor unit 30. This is because the positional deviation tends to be accumulated as a result of linking optional sensor units 30. The positional deviation herein means a phenomenon in which the position of the sheet 1 in the transverse direction of the transport path 201 is changed during transportation of the sheet 1.

By arranging an optional sensor unit 30 whose sensor 31 interferes with a sensor of another sensor unit (which may be either the standard sensor unit 20 or another optional sensor unit 30) apart from such other sensor unit, in other words, by arranging a different optional sensor unit 30 (which may alternatively be a transport unit to be mentioned later) between the interfering sensor units, it is possible to reduce or eliminate the influence of interference. Examples of sensors that interfere with each other include optical sensors that apply light of different wavelength bands to the sheet 1. Adjacently arranging these optical sensors may cause leakage of light applied from one sensor into the other sensor.

In the present embodiment, the optional identifier 16 is designed to be able to appropriately select the output data from a sensor 31 in accordance with the position of the corresponding optional sensor unit 30. This enables a sensor with a large data capacity, such as an optical line sensor for optical variable ink detection, serving as a sensor 31 to be arranged at any position and mounted on any optional sensor unit 30. When an optional sensor unit 30 is disposed at a certain position, the optional controller 18 can obtain medium information before the sheet 1 passes the sensor 31 thereof and collect data corresponding to the medium information (e.g., denomination). This can reduce the capacity of data collected and shorten the identification time when a sensor with a large data capacity is mounted on a downstream optional sensor unit 30. Hereinafter, two specific examples are described below. These examples show cases of attaching four optional sensor units 30 to the option attachment member 12.

### (Case 1)

In Case 1, the sensor 31 of the optional sensor unit 30 that is next to or two units away from (preferably, next to) the standard sensor unit 20 is the optical line sensor for optical variable ink detection. In this case, the sheet 1 usually passes the optical line sensor for optical variable ink detection before the standard identifier 15 determines the type, four orientations, and position (e.g., position in the transverse direction of the transport path 201) of the sheet 1. Thus, as shown in FIG. 6, the optional controller 18 collects the image data of the entire detection surface by the optical line sensor for optical variable ink detection and cuts out a region with an optical variable ink imaged therein from the image data of the entire detection surface to authenticate the optical variable ink. The image data of the entire detection surface means the image data comprising image data of the entire surface of the sheet 1 and image data of the surrounding region (background region).

### (Case 2)

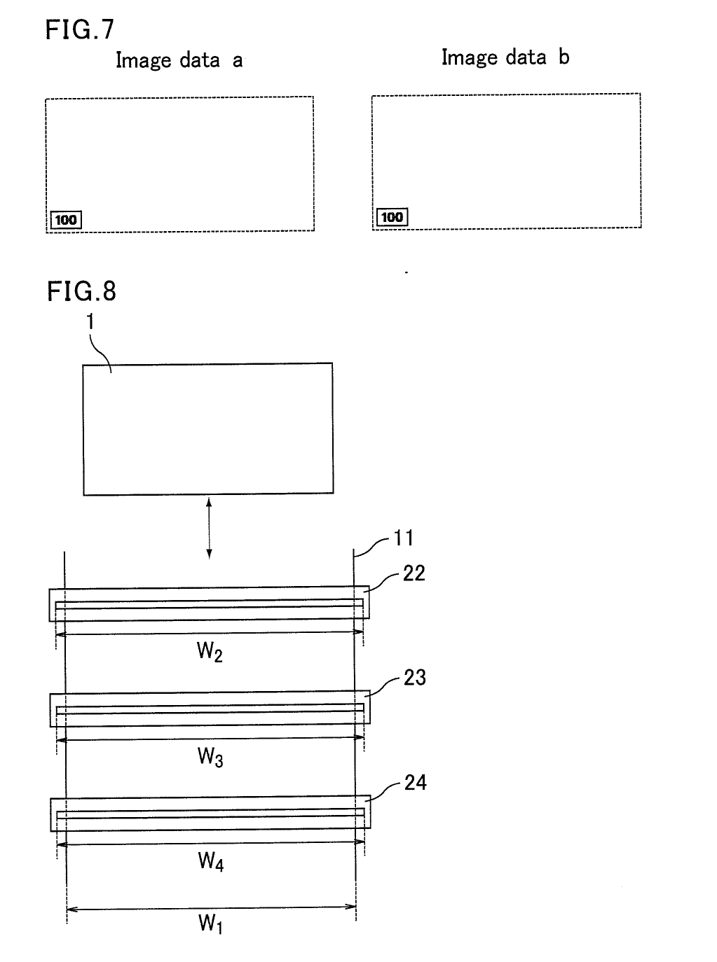

In Case 2, the sensor 31 of the optional sensor unit 30 that is three or four units away from (preferably four units away from, i.e., furthest from) the standard sensor unit 20 is the optical line sensor for optical variable ink detection. In this case, the standard identifier 15 usually determines the type, four orientations, and position (e.g., position in the transverse direction of the transport path 201) of the sheet 1 before the sheet 1 passes the optical line sensor for optical variable ink detection. Thus, as shown in FIG. 7, the optional controller 18 collects only the image data of the region with the optical variable ink imaged therein from the optical line sensor for optical variable ink detection based on these determined pieces of information. The optional controller 18 then authenticates the optical variable ink based on the image data of the region.

As mentioned above, the optional controller 18 may collect the data of the entire detection surface from a sensor 31 of an optional sensor unit 30 before the standard identifier 15 determines the type, four orientations, and position (e.g., position in the transverse direction of the transport path 201) of the sheet 1, while it may collect the data of part of the detection surface of the sensor 31 of the optional sensor unit 30 after the determination.

As described above, in the present embodiment, the sheet identification device 10 is designed such that a plurality of optional sensor units 30 which is unitized in the same shape and have different detection functions can be selected as appropriate, and can be connected and disposed on the post stage of the standard identifier 15. In addition to the standard controller 17 of the standard identifier 15, the optional identifier 16 is provided with the optional controller 18 configured to control the optional sensor units 30.

The plurality of optional sensor units 30 having different detection functions is connected to and disposed on the post stage of the standard identifier 15. This enables expansion of the identification functions of the sheet identification device 10. Then, the optional sensor units 30 enable detection of the security characteristics and damages of the sheet 1 which are difficult to detect by the standard identifier 15 alone.

The optional controller 18 configured to control the optional sensor units 30 is provided for the optional identifier 16. This enables addition of the optional sensor unit 30 with a desired function to the sheet identification device 10 without any limitation by the functions of the standard controller 17. Thus, the sheet identification device 10 can meet a wider variety of requests than the banknote identification device of Patent Literature 1.

The plurality of optional sensor units 30 is unitized in the same shape. This enables selection of any of various sensors 31 and easy expansion of the identification functions. Thus, the sheet identification device 10 can flexibly meet requests different from country to country without excess and deficiency in terms of function and cost.

In the present embodiment, as shown in FIG. 8, the scanning width W₂ of the optical line sensor 22 of the standard identifier 15 is greater than the width W₁ of the transport path 11. Also, the scanning widths of the linear sensors of the standard identifier 15 and the optional identifier 16 other than the optical line sensor 22, such as the scanning width W₃ of the thickness detection sensor 23 and the scanning width W₄ of the magnetic sensor 24, are equal to or greater than the scanning width W₂ of the optical line sensor 22. That is, every linear sensor has a scanning width that is equal to or greater than the width W₁ of the transport path 11. This enables reading of the entire surface of the sheet 1 without exception no matter where the sheet 1 passes in the transport path 11 and no matter what the size of the sheet 1 is. As a result, the device can surely detect the security characteristics and damages of the sheet 1 and can execute identification with improved precision and reproducibility.

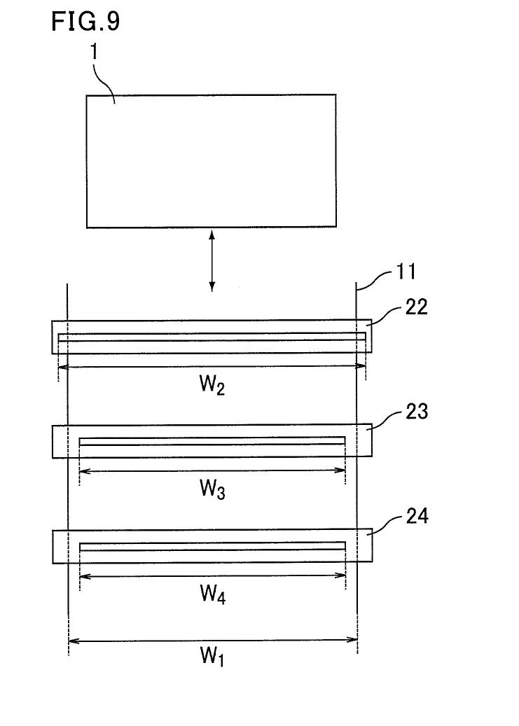

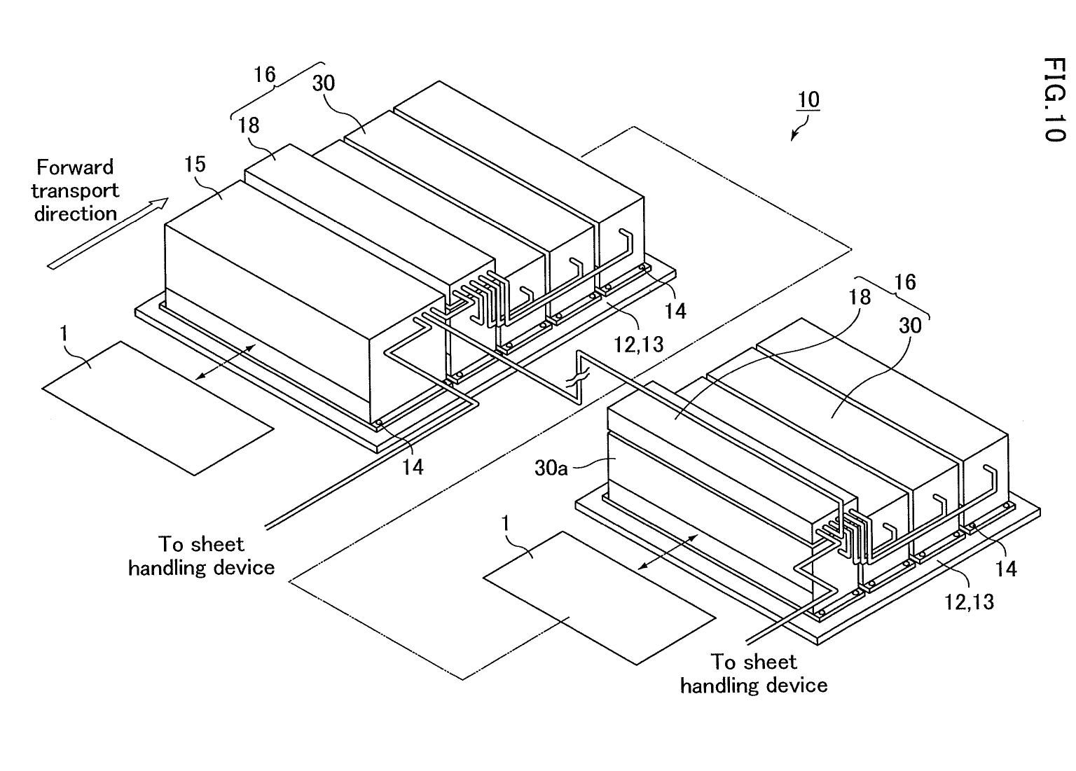

In contrast, as shown in FIG. 9, if the scanning widths of linear sensors other than the optical line sensor 22, such as the scanning width W₃ of the thickness detection sensor 23 and the scanning width W₄ of the magnetic sensor 24, are smaller than the width W₁ of the transport path 11, these sensors fail to read an edge of the sheet 1 when the sheet 1 is close to an edge of the transport path 11 during transportation. Even in this case, by taking measures such as limiting the position of transporting the sheet 1, it is possible to collect data to be processible without problems.

### Embodiment 2

In the present embodiment, the features unique to the present embodiment are mainly described, and the same contents as those in Embodiment 1 are not elaborated upon here. The components having a similar or the same function in both the present embodiment and Embodiment 1 are provided with the same reference sign, and these components are not elaborated upon in the present embodiment. The present embodiment is substantially the same as Embodiment 1, except for the following points.

In the present embodiment, the case of providing an optional identifier apart from a standard identifier is described.

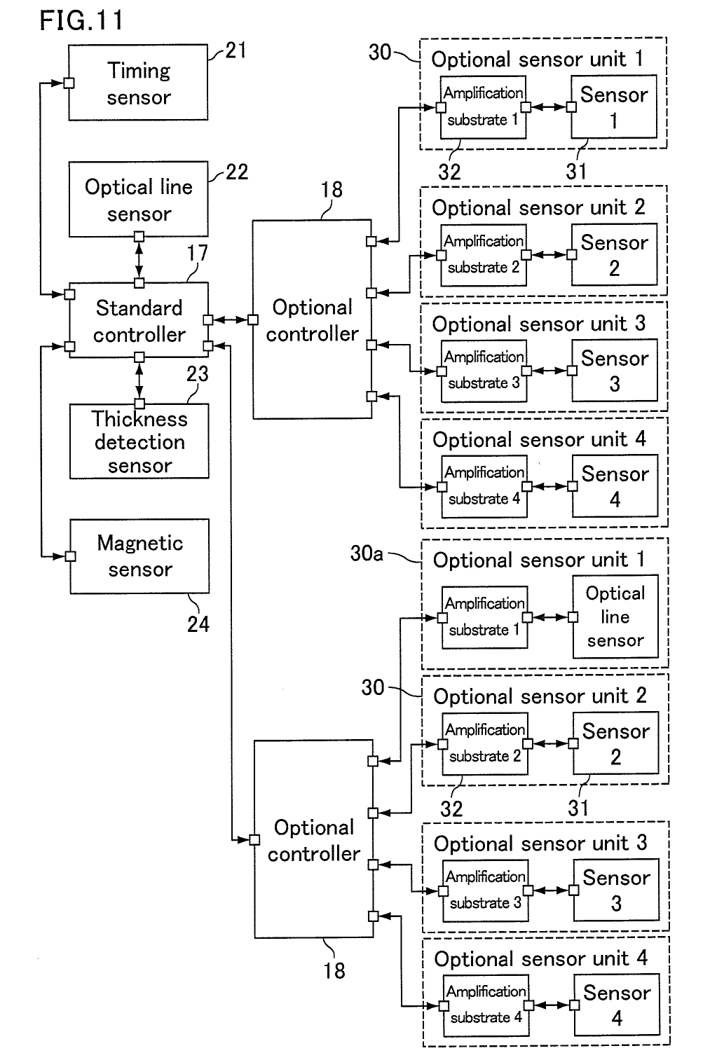

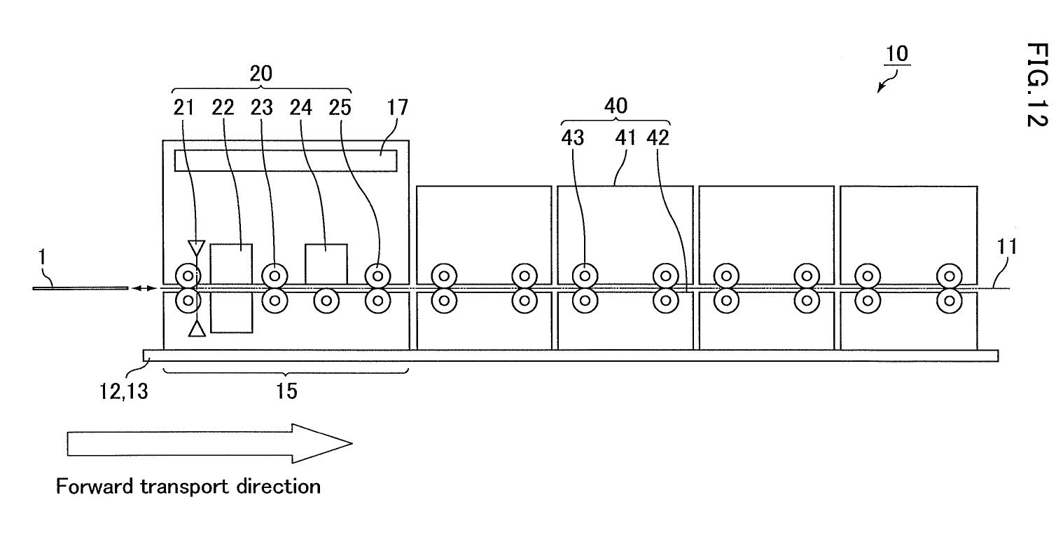

As shown in FIGS. 10 and 11, the sheet identification device 10 of the present embodiment further comprises the option attachment member 12 and the optional identifier 16 apart from the standard identifier 15. The sheet 1 transported in the forward transport direction is to pass the standard identifier 15 and then the optional identifier 16 adjacent to the standard identifier 15, subsequently the optional identifier 16 apart from the standard identifier 15. In contrast, the sheet 1 transported in the reverse transport direction is to pass the optional identifier 16 apart from the standard identifier 15, subsequently the optional identifier 16 adjacent to the standard identifier 15 and then the standard identifier 15.

The optional identifier 16 apart from the standard identifier 15 basically has the same structures and functions as the optional identifier 16 adjacent to the standard identifier 15, and comprises optional sensor units 30 each comprising the sensor 31 and the amplification substrate 32, and the optional controller 18 that is configured to control the sensors 31 of the respective optional sensor units 30 and identify the sheet 1 based on the outputs from the sensors 31 of the respective optional sensor units 30.

It should be noted that the optional identifier 16 apart from the standard identifier 15 is provided with an optional sensor unit 30a designed to be able to detect the transport conditions of a sheet 1 as the forefront optional sensor unit 30 closest to the standard identifier 15 in the transport path of the sheet 1. The optional sensor unit 30a comprises an optical line sensor as the sensor 31, and this optical line sensor is configured to image the entire surface of the sheet 1 and collect the image data of the entire surface of the sheet 1. In consideration of the detection results of this forefront optional sensor unit 30a, each of the following optional sensor units 30 executes the detection.

Examples of the transport conditions of the sheet 1 to be detected by the optional sensor unit 30a include, but are not limited to, the position, the angle, the speed, and a chain of sheets 1.

In the present embodiment, even when the transport conditions of the sheet 1 in the optional sensor unit 30 apart from the standard identifier 15 are different from the transport conditions in the standard identifier 15, the leading optional sensor unit 30a can detect the transport conditions of the sheet 1 again and, based on the detection results, each optional sensor unit 30 on the post stage of the optional sensor unit 30a can detect the sheet 1. This improves the performance of detecting the security characteristics and damage to the sheet 1 by the optional identifier 16 apart from the standard identifier 15.

On the contrary, in the banknote identification device of Patent Literature 2, the identification data acquisition unit is placed apart from the identification unit. Thus, the transport conditions of a banknote passing the identification data acquisition unit may be different from the transport conditions of the banknote passing the identification unit. In such a case, the identification data acquisition unit may fail to precisely read and detect the security characteristics and damages of the banknote.

In the present embodiment, the option attachment member 12 and the optional identifier 16 adjacent to the standard identifier 15 may not be disposed and only the option attachment member 12 and the optional identifier 16 apart from the standard identifier 15 may be disposed.

### Embodiment 3

In the present embodiment, the features unique to the present embodiment are mainly described, and the same contents as those in Embodiment 1 are not elaborated upon here. The components having a similar or the same function in both the present embodiment and Embodiment 1 are provided with the same reference sign, and these components are not elaborated upon in the present embodiment. The present embodiment is substantially the same as Embodiment 1, except for the following points.

In the present embodiment, the case of providing a transporting unit instead of the optional identifier is described.

As shown in FIG. 12, the sheet identification device 10 of the present embodiment comprises one or more transporting units 40 attached to the option attachment member 12. Each transporting unit 40 has a structure in which two substantially cuboid-like housings 41 and 42 that extend in the direction perpendicular to the transport direction of the sheet 1 face each other across the transport path of the sheet 1.

Each transporting unit 40 is provided with a plurality of rollers 43 as a transporter so as to transport the sheet 1 in the transport path 11. The rollers 43 are driven by a driver such as a motor which is not shown in the figure. The sheet 1 is to be transported between the housings 41 and 42 by the rollers 43.

The present embodiment is suitable for the cases where the standard identifier 15 alone can meet the requested identification functions. Since the optional identifier 16 need not to be provided, this embodiment can reduce the cost of the sheet identification device 10. When it becomes necessary to collect data from the optional identifier 16, the transporting unit 40 can be easily replaced by an optional identifier 16 with no effort of collecting and converting the sheet handling device 100.

As mentioned above, the sheet identification devices 10 of the above embodiments each comprise the standard identifier 15 and the option attachment member 12 to which the optional identifier 16 is attachable. The optional identifier 16 comprises the optional sensor units 30 each configured to execute a different sensing operation from a sensing operation executed by the standard sensor unit 20. Thus, the optional sensor units 30 can expand the identifying functions of the sheet identification device 10 and can detect the security characteristics and damages of the sheet 1 which are difficult to detect by the standard identifier 15 alone.

The optional identifier 16 comprises the optional controller 18 configured to control the optional sensor units 30. This enables addition of an optional sensor unit 30 having a desired function to the sheet identification device 10 without any limitation by the functions of the standard controller 17. Thus, the sheet identification device 10 can meet a wider variety of requests than the banknote identification device of Patent Literature 1.

In the above embodiments, the standard identifier 15 is configured to obtain the medium information of the sheet 1 with the standard sensor unit 20 and the optional controller 18 is configured to control the optional sensor units 30 based on the medium information obtained by the standard identifier 15. Thus, the optional sensor units 30 can detect any site on the sheet 1 in a pinpoint manner. This can reduce the influence of noise and can shorten the sampling time. Reduction of noise leads to improvement of the detection precision and identification precision.

In the above embodiments, the optional identifier 16 is attachable to the option attachment member 12 in such a manner that the optional identifier 16 is apart from the standard identifier 15. This can improve the freedom of placing the optional identifier 16, improving the freedom of designing the sheet identification device 10.

In the above embodiments, the optional identifier 16 that is attachable to the option attachment member 12 in such a manner that the optional identifier 16 is apart from the standard identifier 15 comprises a plurality of the optional sensor units 30 and the optional sensor unit 30a at the most upstream position among the plurality of the optional sensor units 30 is configured to detect the transport conditions of the sheet 1. Thus, even when the transport conditions of the sheet 1 in the optional sensor unit 30 apart from the standard identifier 15 are different from the transport conditions in the standard identifier 15, the optional sensor unit 30a can detect the transport conditions of the sheet 1 again and, based on the detection results, each optional sensor unit 30 on the post stage of the optional sensor unit 30a can detect the sheet 1. This improves the precision of detecting the security characteristics and damages of the sheet 1 by the optional identifier 16 apart from the standard identifier 15.

The sheet identification device 10 of the above embodiments comprises the optional identifier 16 attached to the option attachment member 12 or does not comprise the optional identifier 16 but further comprises the transporting unit 40 attached to the option attachment member 12. The former enables expansion of the identification functions of the sheet identification device 10. The latter is suitable for the cases where the standard identifier 15 alone can meet the required identification functions, and can reduce the cost of the sheet identification device 10.

In the above embodiments, the optional identifier 16 comprises the plurality of the optional sensor units 30 and the plurality of the optional sensor units 30 is attachable to the option attachment member 12. This enables further expansion of the identification functions of the sheet identification device 10.

In the above embodiments, each optional sensor unit of the plurality of the optional sensor units 30 is configured to execute a different sensing operation, and thus can further expand the identification functions of the sheet identification device 10.

In the above embodiments, each optional sensor unit of the plurality of the optional sensor units 30 comprises a different sensor. Thus, the optional sensor units 30 can easily execute different respective sensing operations and can easily detect a variety of pieces of the sheet information.

In the above embodiments, each optional sensor unit of the plurality of the optional sensor units 30 has the same dimension in the transport direction of the sheet 1. Thus, an optional sensor unit 30 can be easily added to the option attachment member 12. The phrase “have the same dimension” herein also means the dimensions are substantially the same as each other.

In the above embodiments, each optional sensor unit of the plurality of the optional sensor units 30 is attachable to the same site of the option attachment member 12. Thus, the optional sensor units 30 are arrangeable in any order.

In the above embodiments, each optional sensor unit of the plurality of the optional sensor units 30 is attachable inline to the option attachment member 12. Thus, the optional sensor units 30 enable successive detection of pieces of sheet information in a short time.

In the above embodiments, each optional sensor unit of the plurality of the optional sensor units 30 is arrangeable in any order in the transport direction of the sheet 1. This enables expansion of the identification functions of the sheet identification device 10 while satisfying predetermined conditions (limitations).

In the above embodiments, the optional sensor unit 30 that causes a longer period of identification with the optional controller 18 among the plurality of the optional sensor units 30 is placed at a more upstream position. This can reduce the influence of the time-consuming identification on the entire period of identification.

A sheet identification method of the above embodiments comprises: controlling the standard sensor unit 20 comprising the optical line sensor 22 by the standard controller 17; identifying the type of the sheet 1 by the standard controller 17 based on the output from the standard sensor unit 20; and controlling, by the optional controller 18, at least one optional sensor unit 30 selected from the plurality of the optional sensor units 30, the plurality of the optional sensor units 30 each being configured to execute a different sensing operation from a sensing operation executed by the standard sensor unit 20. Thus, the optional sensor units 30 can expand the identification functions of the standard identifier 15, and can detect the security characteristics and damages of the sheet 1 that are difficult to detect by the standard identifier 15 alone.

The optional sensor units 30 are to be controlled by the optional controller 18. This enables the use of an optional sensor unit 30 having a desired function without any limitation by the functions of the standard controller 17. Thus, the sheet identification device 10 can meet a wider variety of requests than the banknote identification device of Patent Literature 1.

Hereinabove, some embodiments of the present invention are described with reference to the drawings. Still, the present invention is not intended to be limited by the above embodiments. The features of the embodiments may be combined or modified as appropriate within the spirit of the present invention.

### (Variations)

In the above embodiments, the sheet 1 is long-edge fed. Alternatively, the sheet 1 may be short-edge fed.

In the above embodiments, the optional identifier(s) 16 is/are placed on the post stage (downstream) of the standard identifier 15. Alternatively, part or the whole of the optional identifier(s) 16 may be placed at the previous stage (upstream) of the standard identifier 15.

In the above embodiments, a single optional controller 18 controls the plurality of the optional sensor units 30. Alternatively, each optional sensor unit 30 may be provided with a dedicated optional controller.

In the above embodiments, the optional sensor units 30 are provided with the respective amplification substrates 32. Alternatively, any or all of the processing operations by the amplification substrates 32 may be executed by the optional controller 18. In the latter case, placement of the amplification substrates 32 can be excluded.

In the above embodiments, the standard sensor unit 20 comprises the thickness detection sensor 23 and the magnetic sensor 24. These sensors 23 and 24 may be provided for the optional identifier 16, or may be excluded.

In the above embodiments, the rollers 25, 35, and 43 are used as a transporter for the sheet 1. Alternatively, the transporter may not be limited to the rollers, but may be, for example, a transporter comprising a belt.

In the above embodiments, the option attachment member 12 constituted by the flat plate 13 is used. Alternatively, a base plate of the sheet handling device 100 may also be used as an option attachment member of the sheet identification device 10, and to this base plate are attached the standard identifier 15 and the optional identifier 16 directly.

In the above embodiments, either the optional identifier 16 or the transporting unit 40 is attached to the option attachment member 12. Alternatively, both the optional identifier 16 and the transporting unit 40 may be attached to the option attachment member 12.

### INDUSTRIAL APPLICABILITY

As described above, the present invention is a useful technique for identifying sheets.

### REFERENCE SIGNS LIST

1: sheet
10: sheet identification device
11, 201: transport path
12: option attachment member
13: flat plate
14: fixing part
15: standard identifier
16: optional identifier
17: standard controller
18: optional controller
20: standard sensor unit
21: timing sensor
22: optical line sensor
23: thickness detection sensor
24: magnetic sensor
25, 35, 43: roller
30, 30a: optional sensor unit
31: sensor
32: amplification substrate
33, 34, 41, 42: housing
40: transporting unit
100: sheet handling device
101: hopper
102: rejector
103: control panel
105: display
106: stacker
107: housing
110: sheet feeding mechanism
112: feed roller
114: gate roller (reverse roller)
116: first kicker roller
118: second kicker roller
202, 203, 205 to 215: sensor
221 to 224: residual sheet detection sensor
231 to 234: diverter
W₁: width of transport path
W₂: scanning width of optical line sensor
W₃: scanning width of thickness detection sensor
W₄: scanning width of magnetic sensor

1. A sheet identification device configured to identify a sheet under transportation, the device comprising:
a standard identifier; and
an option attachment member to which an optional identifier is attachable,
the standard identifier comprising:
a standard sensor unit comprising an optical line sensor; and
a standard controller configured to control the standard sensor unit and identify a type of the sheet based on an output from the standard sensor unit,
the optional identifier comprising:
an optional sensor unit configured to execute a different sensing operation from a sensing operation executed by the standard sensor unit; and
an optional controller configured to control the optional sensor unit.

2. The sheet identification device according to claim 1,
wherein the standard identifier is configured to obtain medium information of the sheet with the standard sensor unit, and
the optional controller is configured to control the optional sensor unit based on the medium information obtained by the standard identifier.

3. The sheet identification device according to claim 1 or 2,
wherein the optional identifier is attachable to the option attachment member in such a manner that the optional identifier is apart from the standard identifier.

4. The sheet identification device according to claim 3,
wherein the optional identifier attachable to the option attachment member in such a manner that the optional identifier is apart from the standard identifier comprises a plurality of optional sensor units, and
an optional sensor unit at a most upstream position among the plurality of optional sensor units is configured to detect transport conditions of the sheet.

5. The sheet identification device according to claim 1,
wherein the optional controller is configured to determine at least one of authenticity and fitness of the sheet based on an output from the optional sensor unit.

6. The sheet identification device according to claim 1,
wherein the standard controller is configured to determine at least one of authenticity and fitness of the sheet based on the output from the standard sensor unit.

7. The sheet identification device according to claim 1,
wherein the optional sensor unit comprises at least one sensor selected from the group consisting of an ultrasonic sensor, an optical sensor, a magnetic sensor, a displacement sensor, and a capacitive sensor.

8. The sheet identification device according to claim 1, further comprising the optional identifier attached to the option attachment member.

9. The sheet identification device according to claim 1, further comprising a transporting unit attached to the option attachment member, but not comprising the optional identifier.

10. The sheet identification device according to claim 1,
wherein the optional identifier comprises a plurality of optional sensor units, and
the plurality of optional sensor units is attachable to the option attachment member.

11. The sheet identification device according to claim 10,
wherein each optional sensor unit of the plurality of optional sensor units is configured to execute a different sensing operation.

12. The sheet identification device according to claim 11,
wherein each optional sensor unit of the plurality of optional sensor units comprises a different sensor.

13. The sheet identification device according to claim 10,
wherein each optional sensor unit of the plurality of optional sensor units has the same dimension in a transport direction of the sheet.

14. The sheet identification device according to claim 10,
wherein each optional sensor unit of the plurality of optional sensor units is attachable to the same site of the option attachment member.

15. The sheet identification device according to claim 10,
wherein each optional sensor unit of the plurality of optional sensor units is attachable inline to the option attachment member.

16. The sheet identification device according to claim 10,
wherein each optional sensor unit of the plurality of optional sensor units is arrangeable in any order in a transport direction of the sheet.

17. The sheet identification device according to claim 16,
wherein an optional sensor unit that causes a longer period of identification with the optional controller among the plurality of optional sensor units is placed at a more upstream position.

18. A sheet identification method for identifying a sheet under transportation, the method comprising:
controlling a standard sensor unit comprising an optical line sensor by a standard controller;
identifying a type of the sheet by the standard controller based on an output from the standard sensor unit; and
controlling, by an optional controller, at least one optional sensor unit selected from a plurality of optional sensor units, the plurality of optional sensor units each being configured to execute a different sensing operation from a sensing operation executed by the standard sensor unit.
